(19) United States
(12) Patent Application Publication
(10) Pub. No.: US 2026/0195078 A1
(43) Pub. Date: Jul. 9, 2026

(54) PRINTING CONTROL APPARATUS, METHOD FOR CONTROLLING PRINTING CONTROL APPARATUS, AND STORAGE MEDIUM

(71) Applicant: CANON KABUSHIKI KAISHA, Tokyo (JP)

(72) Inventor: RYO HAKATA, Kanagawa (JP)

(21) Appl. No.: 19/437,334

(22) Filed: Dec. 31, 2025

(30) Foreign Application Priority Data
Jan. 7, 2025 (JP) 2025-002463

(51) Int. Cl. G06F 3/12; B41J 3/46; B41J 11/00; B41J 15/04; B41J 15/16

(52) U.S. Cl. CPC G06F 3/1208; B41J 3/46; B41J 11/0095; B41J 15/04; B41J 15/16; G06F 3/1251; G06F 3/1256

(57) ABSTRACT

A printing control apparatus includes a paper feed unit, a winding unit that winds a print sheet fed from the paper feed unit and subjected to printing, where the printing control apparatus receives an input specifying a position on a printed print sheet to be confirmed, and controls conveying the print sheet from the winding unit toward the paper feed unit so that the position on the print sheet specified via the received input is brought into a visually accessible predetermined range instead of a portion where the print sheet is wound into a roll by the winding unit.

### BACKGROUND

### Field of the Technology

The present disclosure relates to a printing control apparatus, a method, and a storage medium that are suitably used for controlling a printing apparatus which winds a printed recording medium into a roll.

### Description of the Related Art

A printing method called roll-to-roll printing is known, in which roll paper is unwound for printing and then rewound into a roll.

Japanese Patent Laid-Open No. 2016-10948 describes, as a technique relating to roll-to-roll printing, a technique for previewing an image rendered on roll paper before print output.

In roll-to-roll printing, in a case where a visual check of a printed result (e.g., the color tone, finish, and other properties of the image printed on roll paper) is desired, it has been necessary to identify a print position on the wound roll paper for which the printed result is to be checked and manually rewind it, which has been cumbersome.

### SUMMARY

The present disclosure is directed to facilitating visual confirmation of a printed result.

According to an aspect of the present disclosure, a printing control apparatus includes a paper feed unit, a winding unit configured to wind a print sheet fed from the paper feed unit and subjected to printing, at least one memory storing a program, and at least one processor, which when executing the program, is caused to receive an input specifying a position on a printed print sheet to be confirmed, and perform control to convey the print sheet from the winding unit toward the paper feed unit so that the position on the print sheet specified via the received input is brought into a visually accessible predetermined range instead of a portion where the print sheet is wound into a roll by the winding unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a printer according to a first embodiment.

FIG. 2 is a diagram illustrating an unwinding and winding mechanism.

FIG. 3 is a diagram illustrating a management table according to the first embodiment.

FIG. 4 is a diagram illustrating an example of a confirmation screen for a printed result according to the first embodiment.

FIG. 5 is a flowchart illustrating processing executed by the printer according to the first embodiment.

FIG. 6 is a diagram illustrating a management table according to a second embodiment.

FIG. 7 is a diagram illustrating an example of a confirmation screen for a printed result according to the second embodiment.

### DESCRIPTION OF THE EMBODIMENTS

Embodiments will be described below with reference to the accompanying drawings.

### First Embodiment

### Configuration of Printer

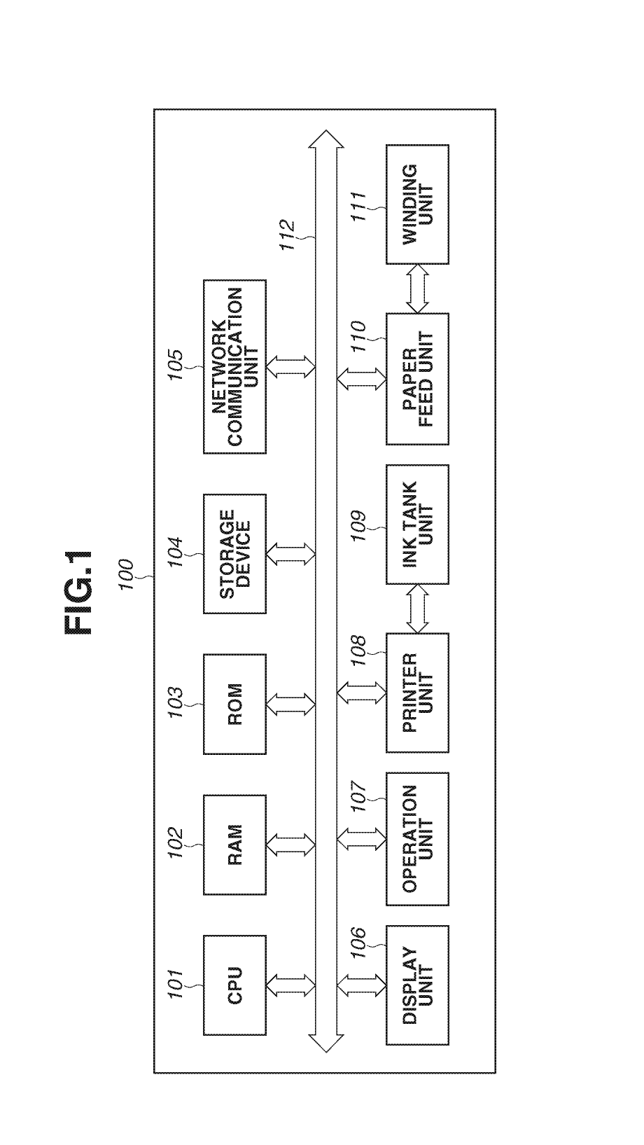

FIG. 1 is a block diagram illustrating a configuration of a printer 100 according to a first embodiment.

The printer 100 includes a central processing unit (CPU) 101, a random access memory (RAM) 102, a read-only memory (ROM) 103, a storage device 104, and a network communication unit 105. The printer 100 also includes a display unit 106, an operation unit 107, a printer unit 108, an ink tank unit 109, a paper feed unit 110, and a winding unit 111. The printer 100 includes a system bus 112 that interconnects the respective units and enables mutual transmission and reception of data.

The CPU 101 is used for controlling each unit of the printer 100. The CPU 101 executes predetermined programs to function as a memory control unit, a display control unit, and a control unit. The RAM 102 stores various program codes. The ROM 103 temporarily stores image data for printing and is used for buffering during execution of various services. The image data for printing is equivalent to print data, and hereinafter is referred to as print data. The storage device 104 is a nonvolatile storage device, such as a magnetic disk or flash memory, and stores various types of information set in the printer 100, the remaining amount of roll paper (including other rolled recording medium) loaded, print data, and other types of data. In a configuration in which various types of information are stored in the ROM 103, the storage device 104 is not an essential element and may be omitted. The network communication unit 105 connects to a network, such as the Internet or a local area network, and communicates with other devices. The RAM 102 also stores print data and other types of data received by the network communication unit 105.

The display unit 106 is, for example, a liquid crystal display (LCD) and displays various types of information. The operation unit 107 includes switches, hard keys, and other components for the user to perform various input operations. The display unit 106 may have a touch panel function and can also serve as the operation unit 107 for input operations. The printer unit 108 prints on a recording medium, such as paper, based on print data received via the network communication unit 105. The ink tank unit 109 stores ink used for printing by the printer unit 108.

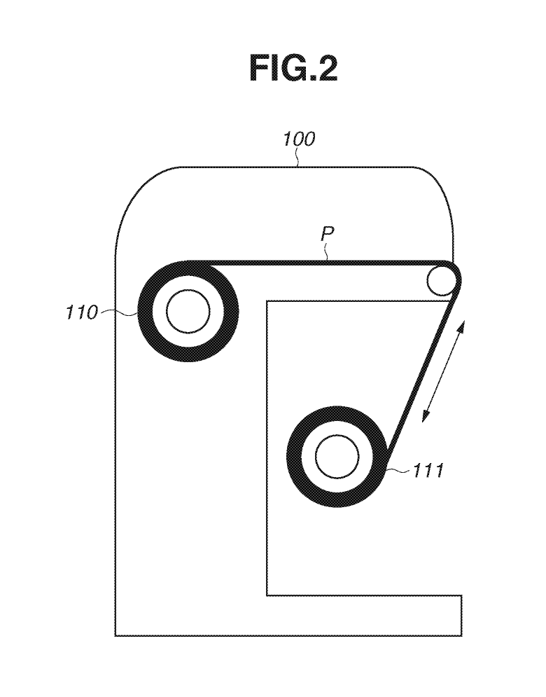

The paper feed unit 110 and the winding unit 111 form an unwinding and winding mechanism for unwinding (feeding out) and winding roll paper. FIG. 2 illustrates the unwinding and winding mechanism and schematically illustrates a cross section of the printer 100. During normal printing, roll paper P is unwound from the paper feed unit 110 toward the winding unit 111, and after printing, is rewound into a roll. When it is desired to check a printed result, the direction of rotation is reversed so that the paper feed unit 110 and the winding unit 111 swap roles, thus enabling bidirectional conveyance of the roll paper P.

### Roll-To-Roll Printing

In response to receiving an instruction to perform roll-to-roll printing, the printer 100 converts received print data into raster data (hereinafter referred to as RIP processing) and generates an image for confirmation (hereinafter referred to as a confirmation image). In response to completion of raster data generation, the printer 100 unwinds blank roll paper loaded in the paper feed unit 110, performs printing with the printer unit 108, and winds the printed paper into a roll with the winding unit 111. The printer 100 determines the current position of the roll paper based on the remaining amount of the roll paper before printing and the amount of roll paper conveyed, and stores the current position in the storage device 104.

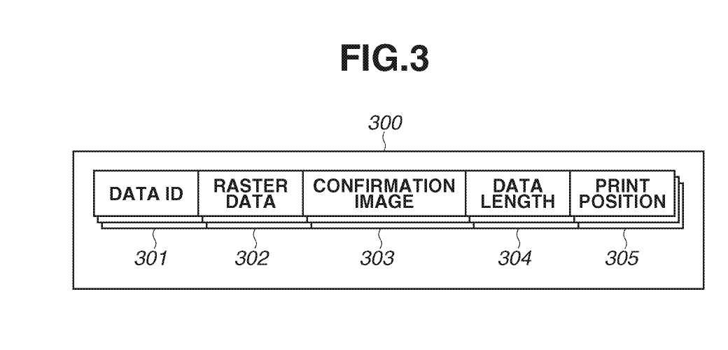

FIG. 3 illustrates a management table 300 that the printer 100 sets print information in and stores the print information in the storage device 104. As illustrated in FIG. 3, in the management table 300, data identifiers (IDs) 301, raster data 302, confirmation images 303, data lengths 304, and print positions 305 are managed. Each piece of data ID 301 is identification information that is uniquely assigned to a piece of print data and is used to identify the piece of print data. Each piece of raster data 302 is a piece of RIP-processed print data used for printing on roll paper. Each confirmation image 303 is generated from the corresponding print data. Each data length 304 is the amount of roll paper conveyed during the corresponding printing. Each print position 305 indicates the print position of the corresponding print data and may, for example, include page information. Each piece of print information set in the management table 300 is stored in the storage device 104 until the corresponding print data is deleted. The current positions and the print positions 305 of roll paper are initialized when the roll paper is removed from the printer 100.

### Linked Processing Between Display for Printed Result Confirmation and Roll Paper Unwinding and Winding

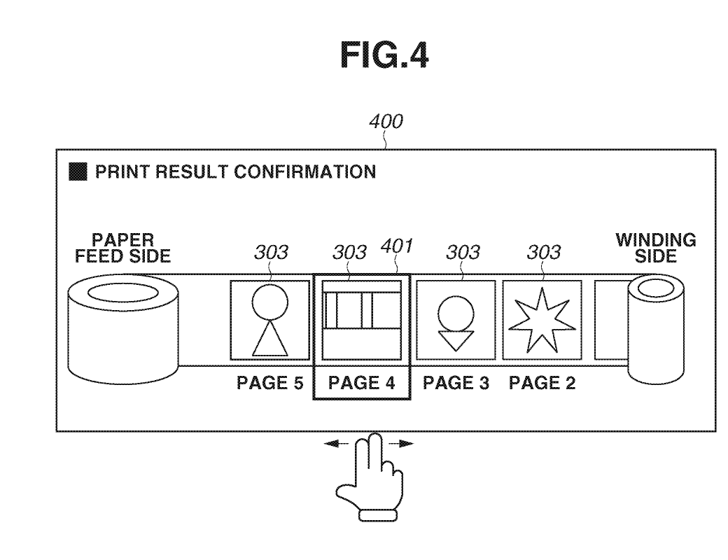

FIG. 4 illustrates an example of a print result confirmation screen 400. The CPU 101 controls display of the print result confirmation screen 400 on the display unit 106 after completion of roll-to-roll printing. The print result confirmation screen 400 displays printed results for confirmation. The print result confirmation screen 400 includes "paper feed side" that corresponds to the paper feed unit 110, and "winding side" that corresponds to the winding unit 111. Confirmation images 303 set in the management table 300 are listed and displayed as images printed on roll paper. A frame 401 for specifying any of the confirmation images 303 is displayed on the print result confirmation screen 400. Panel operations, such as swipe, slide, and flick, on the print result confirmation screen 400 enable page advance and page return, and the confirmation image 303 to be specified (displayed in the frame 401) can be changed. While panel operations have been described, these are merely examples and are not seen to limit the present embodiment. For example, key operations using soft keys or hard keys, or inputting the print position as a numerical value to perform page advance and page return operations may also be employed.

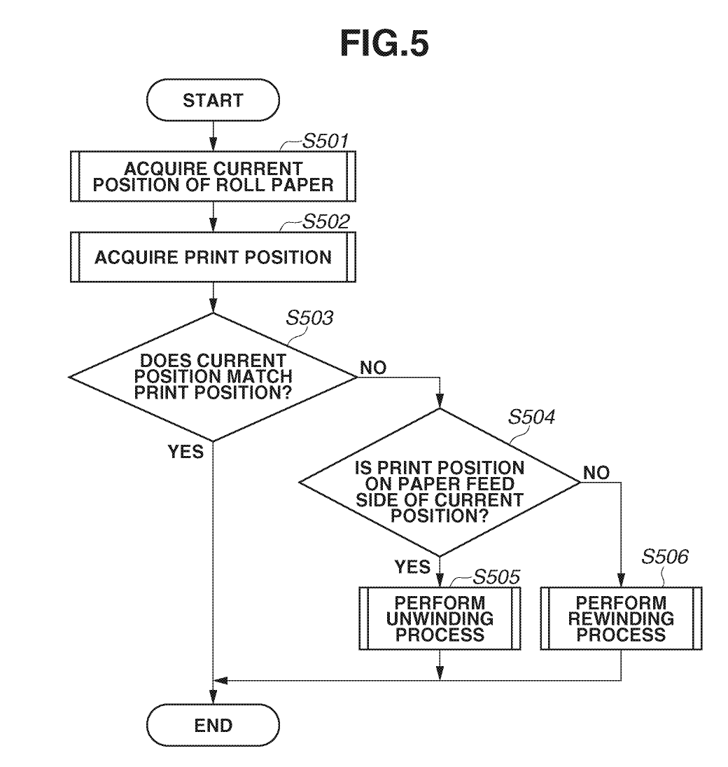

FIG. 5 is a flowchart illustrating processing executed by the printer 100 and indicating a series of processes performed when a page advance or page return operation is performed on the print result confirmation screen 400.

The flowchart illustrated in FIG. 5 is realized by the CPU 101 executing a predetermined program.

In step S501, the CPU 101 acquires the current position of the roll paper stored in the storage device 104.

In step S502, the CPU 101 acquires a print position corresponding to a confirmation image 303 that is specified on the print result confirmation screen 400 from the management table 300 in the storage device 104.

In step S503, the CPU 101 compares the current position of the roll paper acquired in step S501 with the print position acquired in step S502 and determines whether they match.

In step S503, if the current position of the roll paper acquired in step S501 and the print position acquired in step S502 match (YES, in step S503), the processing ends. If the current position of the roll paper and the print position do not match (NO, in step S503), the processing proceeds to step S504.

In step S504, the CPU 101 determines whether the print position acquired in step S502 is on the paper feed side of the current position of the roll paper acquired in step S501. If the print position is on the paper feed side of the current position (YES in step S504), the processing proceeds to step S505. If the print position is not on the paper feed side (NO in step S504), i.e., is on the winding side of the current position, the processing proceeds to step S506.

In step S505, the CPU 101 performs an unwinding process for the roll paper. Unwinding refers to the operation from the standpoint of the paper feed unit 110, and from the standpoint of the winding unit 111, the operation in step S505 corresponds to winding. In other words, as in the paper feeding operation for roll paper, the winding process involves the paper feed unit 110 and the winding unit 111 rotating forward in coordination, and feeding the roll paper toward the winding unit 111 by an amount corresponding to the difference between the current position and the print position. This process can position an actual printed image corresponding to the confirmation image 303 specified on the print result confirmation screen 400 at a location where the roll paper is unwound into a roll, enabling visual confirmation of the printed result. In response to completion of this winding process, information about the current position of the roll paper stored in the storage device 104 is updated to the print position.

In step S506, the CPU 101 performs a rewinding process for the roll paper through winding. Rewinding refers to the operation from the standpoint of the paper feed unit 110, and from the standpoint of the winding unit 111, the operation in step S506 corresponds to unwinding. In other words, the rewinding process involves the paper feed unit 110 and the winding unit 111 rotating in reverse in coordination, and, in a manner opposite to the operation in step S505, feeding the roll paper toward the paper feed unit 110 by an amount corresponding to the difference between the current position of the roll paper and the print position. This process can position the actual printed image corresponding to the confirmation image 303 specified on the print result confirmation screen 400 at a location where the roll paper is unwound into a roll, enabling visual confirmation of the printed result. In response to completion of this rewinding process, information about the current position of the roll paper stored in the storage device 104 is updated to the print position.

As described above, based on an instruction on the print result confirmation screen 400, the CPU 101 executes control for unwinding and winding roll paper to coordinate the unwinding and winding of the roll paper, thus enabling easy visual confirmation of the printed result. This configuration enables the user to visually confirm the color tone, finish, and other properties of the image printed on the roll paper. Some printers include an automatic print job replacement function to ensure appropriate drying time according to the amount of ink and to optimize heating and cooling time of a heater between print jobs. In such cases, the technique according to the present embodiment also enables visual confirmation of a printed result after the job replacement.

While the print result confirmation screen 400 is displayed on the display unit 106 after completion of roll-to-roll printing, this is not limiting. For example, during roll-to-roll printing, a preview display similar to that illustrated in FIG. 4 may be provided on the display unit 106, and after completion of the roll-to-roll printing, the preview display may be used as the print result confirmation screen 400.

Control for unwinding and winding of the roll paper may be performed based on the drying time of the ink used for printing. For example, the unwinding process in step S505 and the rewinding process in step S506 may be enabled after an ink drying time stored in a program code of the RAM 102 has elapsed from completion of printing, taking into account the ink drying time.

In a case where a deviation occurs between the position of the confirmation image 303 specified on the print result confirmation screen 400 displayed on the display unit 106 and the position of the roll paper that has been subjected to the unwinding process in step S505 or the rewinding process in step S506, the operation unit 107 may be used to input an error amount to update information about the corresponding print position 305.

A sensor for detecting rotation may be disposed in the paper feed unit 110 or the winding unit 111, and when the roll paper is manually rotated, the print result confirmation screen 400 may be updated in response to the rotation so that the confirmation image 303 surrounded by the frame 410 is changed, thus performing page forward or page return.

The print result confirmation screen 400 may enable reprinting to be instructed. In a case where the quality level of the visually confirmed printed result is unacceptable, and reprinting is instructed via the operation unit 107, the raster data 302 corresponding to the confirmation image 303 specified on the print result confirmation screen 400 may be read from the management table 300 to perform reprinting.

### Second Embodiment

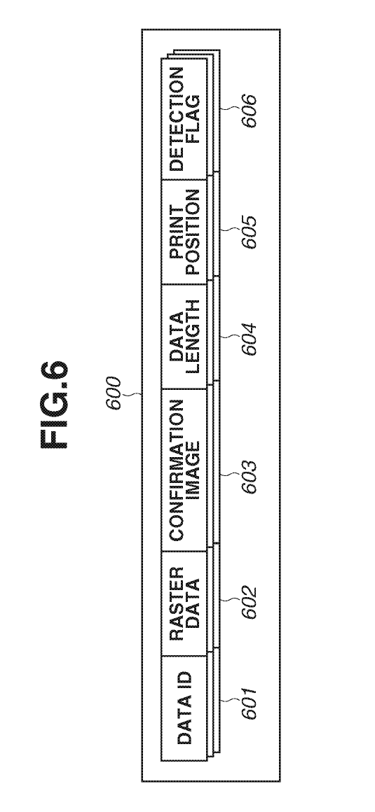

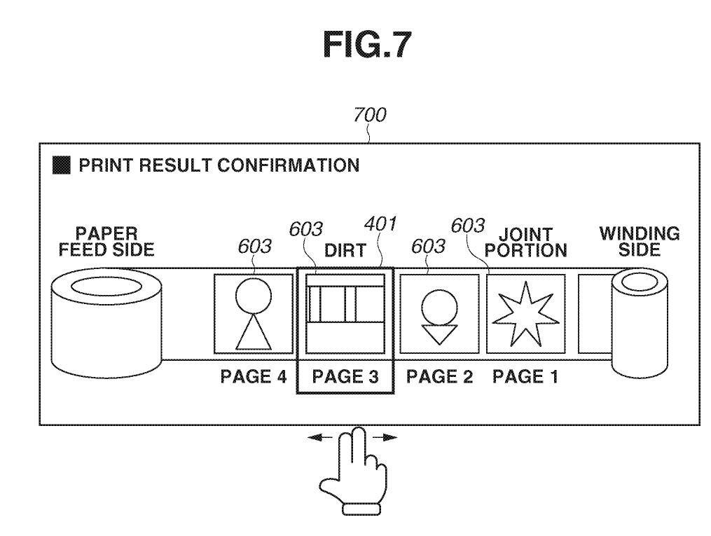

Next, a second embodiment will be described with reference to FIG. 6 and FIG. 7. The configuration and basic processing operations of the printer 100 according to the second embodiment are similar to those described in the first embodiment. Hereinafter, descriptions of common points with the first embodiment will be omitted, and differences from the first embodiment will be mainly described.

In the present embodiment, as illustrated in FIG. 6, the printer 100 sets print information in a management table 600 and stores the print information in the storage device 104. The management table 600 manages data IDs 601, raster data 602, confirmation images 603, data lengths 604, print positions 605, and detection flags 606. The field for the data IDs 601 to the field for the print positions 605 are similar to those for the data IDs 301 to print positions 305 in the first embodiment. Each detection flag 606 is information serving as a marker, for example, indicating dirt adhering to roll paper or a joint portion of roll paper. In roll-to-roll printing, the leading edge of roll paper is fixed to the winding unit 111, and in some cases, another sheet is joined to the leading edge of the roll paper and fixed to the winding unit 111 to enable economical operation without wasting paper. In such cases, the thickness increases at the joint portion where sheets are connected, and the distance between a recording head and a recording medium may become too close or contact each other, possibly resulting in reduced print quality. In the present embodiment, in a case where a portion overlapping with another sheet is detected by a transmission-type sensor as in Japanese Patent Laid-Open No. 2001-239715, or in a case where dirt is detected by an optical sensor, the detection position is set to the corresponding print position 605 and detection details (such as information indicating joint present, dirt present) is set to the corresponding detection flag 606. The print information set in the management table 600 is stored in the storage device 104 until the corresponding print data is deleted. The current positions of the roll paper, the print positions 605, and the detection flags 606 are initialized when the roll paper is removed from the printer 100.

FIG. 7 illustrates an example of a print result confirmation screen 700. The CPU 101 controls displaying the print result confirmation screen 700 on the display unit 106 after completion of roll-to-roll printing. The print result confirmation screen 700 is similar to the print result confirmation screen 400 in the first embodiment, and in addition, information set in the detection flag 606 is displayed. Thus, as in the first embodiment, the second embodiment enables easy visual confirmation of the printed result and visual confirmation focused on portions that may directly lead to a reduction in print quality.

While the embodiments of the present disclosure have been described above, these embodiments are merely examples, and the technical scope of the present disclosure should not be interpreted in a limited manner by these examples. In other words, the present disclosure can be implemented in various forms without departing from its technical concept or main features.

In the above-described embodiments, the printer 100 functions as a printing apparatus and its control apparatus, but this is not limiting. The printing apparatus and its control apparatus are not limited to an integrated configuration, and may be configured as separate devices.

According to the present disclosure, visual confirmation of a printed result can be facilitated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-002463, filed January 7, 2025, which is hereby incorporated by reference herein in its entirety.

What is claimed is:

1. A printing control apparatus comprising:
a paper feed unit;
a winding unit configured to wind a print sheet fed from the paper feed unit and subjected to printing; and
at least one memory storing a program and at least one processor, which when executing the program, is caused to:
receive an input specifying a position on a printed print sheet to be confirmed, and
perform control to convey the print sheet from the winding unit toward the paper feed unit so that the position on the print sheet specified via the received input is brought into a visually accessible predetermined range instead of a portion where the print sheet is wound into a roll by the winding unit.

2. The printing control apparatus according to claim 1,
wherein the at least one processor is further caused to control a display unit to display a confirmation image generated from print data used for printing on the print sheet, and
wherein the input is received while the confirmation image is being displayed.

3. The printing control apparatus according to claim 2,
wherein the at least one processor is further caused to display the confirmation image corresponding to a part of the printed print sheet, and
wherein the received input is an operation for specifying the confirmation image displayed on the display unit.

4. The printing control apparatus according to claim 3, wherein the at least one processor is further configured to change the confirmation image displayed on the display unit in response to an operation to change the part of the printed print sheet.

5. The printing control apparatus according to claim 3, wherein the at least one processor is further configured to perform control to display, on the display unit, a first display object corresponding to the paper feed unit and a second display object corresponding to the winding unit, and to perform control to display the confirmation image at a position between the first display object and the second display object.

6. The printing control apparatus according to claim 3, wherein the at least one processor is further configured to, in response to a part of the print sheet in the predetermined range having been manually changed, change the confirmation image displayed on the display unit so that the confirmation image corresponding to the part of the print sheet in the predetermined range is displayed.

7. The printing control apparatus according to claim 3, wherein the at least one processor is further configured to, in response to an instruction, control reprinting of print data corresponding to the confirmation image displayed on the display unit.

8. The printing control apparatus according to claim 2, wherein the at least one processor is further configured to display, together with the confirmation image, at least one of a joint portion of the print sheet or dirt on the print sheet detected by a sensor.

9. The printing control apparatus according to claim 1,
wherein the at least one processor is further configured to perform the control to convey the print sheet from the winding unit toward the paper feed unit in a case where the position, on the print sheet specified via the received input is on a winding unit side of the position on the print sheet located in the predetermined range, and
wherein the at least one processor is further configured to perform control to convey the print sheet from the paper feed unit toward the winding unit in a case where the position, on the print sheet specified via the received input is on a paper feed unit side of the position on the print sheet located in the predetermined range.

10. The printing control apparatus according to claim 1, wherein the at least one processor is further configured to perform the control to convey the print sheet from the winding unit toward the paper feed unit in a case where the position on the print sheet specified via the received input is on a winding unit side of the position on the print sheet located in the predetermined range after completion of printing on the print sheet.

11. The printing control apparatus according to claim 1, wherein the at least one processor is further configured to perform the control to convey the print sheet from the winding unit toward the paper feed unit in a case where the position on the print sheet specified via the received input is on a winding unit side of the position on the print sheet located in the predetermined range after a lapse of time to dry ink used for printing on the print sheet.

12. A method for controlling a printing control apparatus including a paper feed unit and a winding unit configured to wind a print sheet fed from the paper feed unit and subjected to printing, the method comprising:
receiving an input specifying a position on a printed print sheet to be confirmed; and
performing control to convey the print sheet from the winding unit toward the paper feed unit so that the position on the print sheet specified via the received input is brought into a visually accessible predetermined range instead of a portion where the print sheet is wound into a roll by the winding unit.

13. A non-transitory computer-readable storage medium storing one or more programs for executing a method for controlling a printing control apparatus including a paper feed unit and a winding unit configured to wind a print sheet fed from the paper feed unit and subjected to printing, the method comprising:
receiving an input specifying a position on a printed print sheet to be confirmed; and
performing control to convey the print sheet from the winding unit toward the paper feed unit so that the position on the print sheet specified via the received input is brought into a visually accessible predetermined range instead of a portion where the print sheet is wound into a roll by the winding unit.
